(19) United States
(12) Patent Application Publication
(10) Pub. No.: US 2008/0122873 A1
(43) Pub. Date: May 29, 2008

(54) Flat panel display and driving method of the same

(75) Inventors: Young Jun Hong, Dalseo-gu (KR); Sujin Baek, Geoje-si (KR)

Correspondence Address: KED & ASSOCIATES, LLP, P.O. Box 221200, Chantilly, VA, 20153-1200, US

(73) Assignee: LG Electronics Inc.

(21) Appl. No.: 11/707,047

(22) Filed: Feb. 16, 2007

(30) Foreign Application Priority Data
Nov. 29, 2006 (KR) 10-2006-0119394

(51) Int. Cl. G09G 5/10

(52) U.S. Cl. 345/690

(57) ABSTRACT

A flat panel display and a diving method of the same are provided. The flat panel display comprising a controller that comprises a processing unit for processing a digital signal corresponding to one frame to n number of digital sub-frame signals, a driver that receives the digital sub-frame signals from the controller to generate the n number of analog sub-frame signals and supplies the analog sun-frame signals to a display unit, and a display unit that receives the analog sub-frame signals to embody images, wherein an average of brightness corresponding to the n number of digital sub-frame signals is substantially equal to brightness of the digital signal corresponding to one frame, and the number of bits of digital sub-frame signals is smaller than that the number of bits of the digital signal.

This application claims priority to and the benefit of Korea Patent Application No. 10-2006-0119394, filed on Nov. 29, 2006, the entire content of which is incorporated herein by reference.

### BACKGROUND

1. Field

This document relates to a flat panel display and a driving method of the same.

2. Related Art

Recently, a flat panel display (FPD) increases its importance with development of multimedia. Accordingly, various flat panel displays such as a liquid crystal display (LCD), a plasma display panel (PDP), a field emission display (FED), and an organic light emitting device are used.

Among them, flat panel displays whose each sub-pixel is formed in an area in which the N×M number of data lines and scan lines intersect in a matrix form receive a data signal and a scan signal from a driver electrically connected thereto, thereby expressing a desired image.

In order to improve an image quality of the flat panel display, various gray scales should be able to express and in order to express various gray scales, the number of bits of a digital data signal is increased. However, in order to embody various gray scales, the output bit number of the driver should be also increased, whereby a device restriction problem according to a gray scale expression generates

### SUMMARY

An object of this document is to provide a flat panel display and a driving method thereof that can solve a device restriction problem by decreasing an output bit of a driver through processing a digital signal into the n number of digital sub-frame signals and transmitting the processed n number of digital sub-frame signals.

In an aspect, a flat panel display comprising: a controller that comprises a processing unit for processing a digital signal corresponding to one frame to n number of digital sub-frame signals; a driver that receives the digital sub-frame signals from the controller to generate the n number of analog sub-frame signals and supplies the analog sun-frame signals to a display unit; and a display unit that receives the analog sub-frame signals to embody images, wherein an average of brightness corresponding to the n number of digital sub-frame signals is substantially equal to brightness of the digital signal corresponding to one frame, and the number of bits of digital sub-frame signals is smaller than that the number of bits of the digital signal.

In another aspect, a driving method of a flat panel display comprising: supplying a scan signal to a display unit comprising sub-pixels positioned at an intersection area of scan lines and data lines through the scan lines; processing a digital signal corresponding to one frame supplied from the outside to the n number of digital sub-frame signals; and converting the n number of digital sub-frame signals into the n number of analog sub-frame signals and supplying the n number of analog sub-frame signals to the display unit through the data lines, wherein an average of brightness corresponding to the n number of digital sub-frame signals is substantially equal to brightness of the digital signal before being processed; and the number of bits of the n number of digital sub-frame signals is smaller than that of the digital signal.

### BRIEF DESCRIPTION OF THE DRAWINGS

The implementation of this document will be described in detail with reference to the following drawings in which like numerals refer to like elements.

FIG. 1 is a block diagram of a flat panel display in an implementation of this document;

FIG. 2 is a block diagram illustrating a digital signal processing in an implementation of this document; and

FIG. 3 is a flowchart illustrating a driving method of a flat panel display in an implementation of this document.

### DETAILED DESCRIPTION

An implementation of this document will be described with reference to the accompanying drawings. However, this document is not limited to an implementation described below, but may be embodied in a variety of forms. In the drawings, if it is mentioned that a layer is positioned on a different layer or a substrate, the layer may be formed directly on the different layer or the substrate, or another layer may be interposed therebetween. Like reference numerals designate like elements.

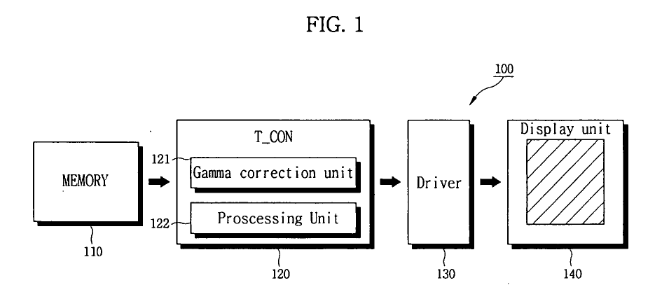

FIG. 1 is a block diagram of a flat panel display in an implementation of this document.

The flat panel display 100 shown in FIG. 1 comprises a memory 110, a controller 120, a driver 130, and a display unit 140. The memory 110 stores a video signal received from the outside as a digital signal, and each digital signal corresponds to one frame.

The controller 120 comprises a gamma correction unit 121 for correcting a digital signal corresponding to one frame received from the memory 110. The controller 120 comprises a processing unit 122 for processing digital signals gamma-corrected to generate the n number of digital sub-frame signals.

An average of brightness corresponding to the n number of digital sub-frame signals processed by the processing unit 122 is substantially equal to brightness of a digital signal corresponding to one frame before being processed, and the number of bits of the n number of digital sub-frame signals are smaller than that of the digital signal.

The n number of digital sub-frame signals are supplied to the driver 130, and the driver 130 converts the n number of digital sub-frame signals to the n number of analog sub-frame signals and supplies each of the n number of analog sub-frame signals to the display unit 140 during the n number of sub-frames.

The display unit 140 comprises sub-pixels positioned at an intersection area of the scan lines and the data lines. Each sub-pixel may comprise a first electrode, a second electrode, and an organic light emitting layer or a liquid crystal layer positioned between the first electrode and the second electrode. That is, a flat panel display may be an organic light emitting display or a liquid crystal flat display. Further, each sub-pixel may comprise at least one thin film transistor and capacitor.

The display unit 140 embodies an image corresponding to the n number of digital sub-frame signals during the n number of sub-frames, and brightness embodied during one frame can be substantially equal to brightness corresponding to a digital signal corresponding to one frame stored in a memory.

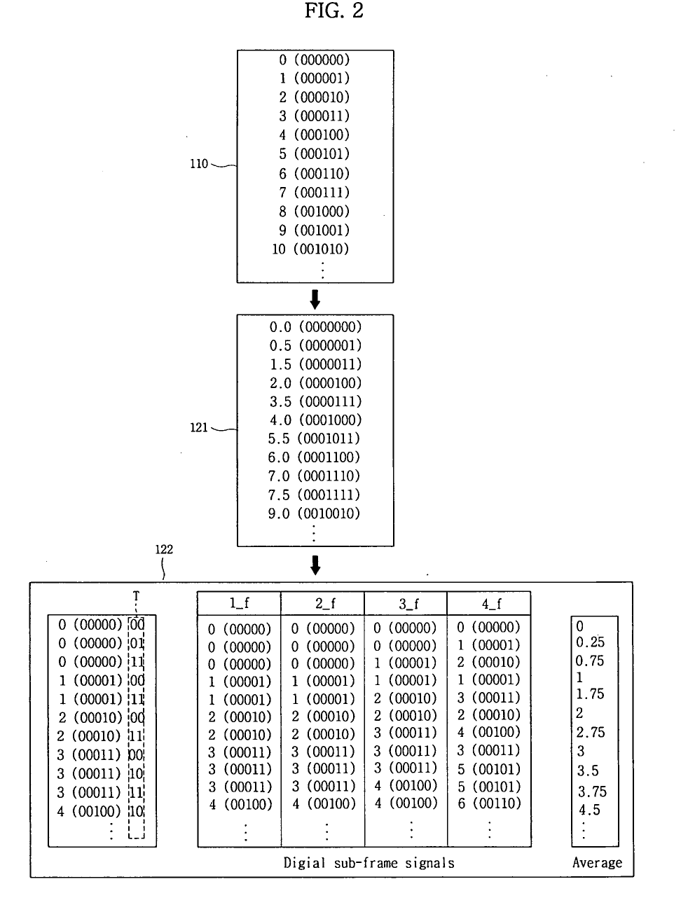

FIG. 2 is a block diagram illustrating a digital signal processing of a flat panel display in an implementation of this document.

For better comprehension and ease of description of this document, a digital signal corresponding to one frame stored in the memory 110 is defined to 6 bits. A digital signal output from the gamma correction unit 121 of the controller 120 is defined to 7 bits, and the n number of digital frame signals output through the processing unit 122 is defined to 5 bits. However, this document is not limited to the number of bits of the previously defined signal.

Referring to FIG. 2, a 6 bit digital signal stored in the memory 110 is output to the gamma correction unit 121. The gamma correction unit 121 corrects the digital signals using a gamma curve, which is a kind of a nonlinear transfer function considering characteristics of the flat panel display. The gamma correction unit 121 may comprise a look-up table (LUT), and the digital signals are corrected by the LUT of the gamma correction unit. When the flat panel display is an organic light emitting display, the gamma curve line can be formed to correspond to light emitting characteristics, particularly, characteristics of a light emitting material of an organic light emitting layer.

In an implementation of this document, the gamma correction unit 121 corrects the 6 bit digital signal by increasing the number of bits of a digital signal. Herein, the number of bits of the corrected digital signal is 7 bit.

However, unlike the present implementation, although digital signals are corrected by the gamma correction unit 121, the number of bits of the corrected digital signals may be substantially equal to that before being corrected, and as the number of bits of the corrected digital signals increases, a gray scale can be more minutely expressed.

The 7 bit digital signals output from the gamma correction unit 121 are supplied to a processing unit. In order to reduce the output bit number of the driver, the processing unit 122 processes the 7 bit digital signals to generate four 5 bit digital sub-frame signals by deleting the lower bit of 7 bit digital signals.

The processing unit 122 processes the 7 bit digital signals so that brightness corresponding to the 7 bit digital signals may be substantially equal to brightness corresponding to four 5 bit digital sub-frame signals.

For example, the processing unit 122 generates four 5 bit digital sub-frame signals with 7 bit digital signals. Among them, two digital sub-frame signals are a value cut lower two bits of the 7 bit digital signal, and one digital sub-frame signal is a value which a lower bit of cut two bits is added to the value cut lower two bits of the 7 bit digital signal, and the remaining one digital sub-frame signal is a value which an upper bit of the cut two bits is added to a value cut lower two bits of the 7 bit digital signal.

That is, when lower 2 bits of the 7 bit digital signal corrected through the gamma correction unit 121 are ‘00’, a magnitude of four digital sub-frame signals output through the processing unit 122 are equal during four sub-frames, and when lower 2 bits are ‘01’, ‘10’, or ‘11’, at least one of a magnitude of four digital sub-frame signals output through the processing unit 122 is different.

For better comprehension and ease of description, a series of processes are described using digital signals “3 (000011)”, “4 (000100)”, and “8 (001001)” among memory values shown in FIG. 2.

First, in an example of the digital signal “3 (000011)”, a 6 bit digital signal “3 (000011)” stored in the memory 110 increases by 1 bit through the LUT of the gamma correction unit 121 to be “2 (0000100)”. A 7 bit digital signal “2 (00001 00)” is processed to generate four digital sub-frame signals.

The four digital sub-frame signals are 5 bit digital signal “1 (00001)” by erasing lower 2 bits of the 7 bit signal. Since lower 2 bits of 7 bits are “00,” four digital frame signals are substantially equal to each other. That is, the processing unit 122 outputs “1 (00001), 1 (00001), 1 (00001), and 1 (00001)” during four sub-frames.

An average of four digital sub-frame signals is displayed as “1,” but the lowest bit of the digital sub-frame signals has substantially the same value as that of a lower third bit of a digital signal corrected in the gamma correction unit. That is, an average of the corrected digital signal and four digital sub-frame signals is equal as “2.” Accordingly, the driver 130 receives four 5 bit digital sub-frame signals and converts four 5 bit digital sub-frame signals to four analog sub-frame signals so that an average of brightness of four 5 bit digital sub-frame signals and brightness of the corrected 7 bit digital signal may be substantially equal to each other.

Accordingly, a data signal quantity substantially supplied to the display unit 140 is substantially equal to “3.5,” which is a value of the gamma correction unit 121, and thus brightness thereof is equally embodied in the display unit 140.

Next, as an example, a digital signal “4 (000100)” is described.

The 6 bit digital signal “4 (000100)” of the memory 110 increases by 1 bit by the gamma correction unit 121 to be a 7 bit digital signal “1 (0000111)”. The 7 bit digital signal “1 (0000111)” is processed to generate four digital sub-frame signals.

At this time, the processing unit 122 generates two 5 bit digital sub-frame signals “1 (00001)” by cutting lower 2 bits of the 7 bit digital signal “1 (0000111)”. Thereafter, a lower bit of the cut 2 bits is added to the 5 bit digital sub-frame signal, and an upper bit of the cut 2 bits is added to the 5 bit digital sub-frame signal, whereby two sub-frame signals are generated. That is, four digital sub-frame signals are “1 (00001), 1 (00001), 2 (00010), and 3 (00011)”.

An average of four digital sub-frame signals are described as “1.75,” but the lowest bit of the 5 bit digital sub-frame signal is substantially equal to a lower third bit of the 7 bit digital sub-frame signal. That is, an average of the corrected digital signal and four digital sub-frame signals is equal as 3.5. Accordingly, the driver 130 receives four 5 bit digital sub-frame signals and converts four 5 bit digital sub-frame signals to four analog sub-frame signals so that an average of brightness of four 5 bit digital sub-frame signals and brightness of the corrected 7 bit digital signal may be substantially equal to each other.

Accordingly, a data signal quantity substantially supplied to the display unit 140 is substantially equal to “3.5,” which is a value of the gamma correction unit 121, and thus brightness thereof is equally embodied in the display unit 140.

Next, as an example, the digital signal “8 (001001)” is described.

A digital signal “8 (001000)” stored in the memory 110 becomes “7 (0001110)” increased by 1 bit through the gamma correction unit 121. The digital signal “7 (0001110)” is processed to generate four digital sub-frame signals through the processing unit 122.

At this time, the processing unit 122 generates two 5 bit digital sub-frame signals “3 (00011)” by cutting lower 2 bits of 7 bits. Thereafter, a lower bit of the cut bits 10 is added to the 5 bit digital sub-frame signal “3 (00011)”, and an upper bit of the cut bits 10 is added to the 5 bit digital sub-frame signal “3 (00011)”, whereby two digital sub-frame signals are generated. That is, four 5 bit digital sub-frame signals are “3 (00011), 3 (00011), 3 (00011), and 5 (00101)”.

Although an average of the digital sub-frame signals is displayed as “3.5,” the lowest bit of the 5 bit digital sub-frame signal is substantially equal to a lower third bit of the 7 bit digital sub-frame signal. That is, an average of the corrected digital signal and four digital sub-frame signals is equal as “7.” Accordingly, the driver 130 receives four 5 bit digital sub-frame signals and converts four 5 bit digital sub-frame signals to four analog sub-frame signals so that an average of brightness of four 5 bit digital sub-frame signals and brightness of the corrected 7 bit digital signal may be substantially equal to each other.

Accordingly, a data signal quantity substantially supplied to the display unit 140 is substantially equal to “7,” which is a value of the gamma correction unit 121, and thus brightness thereof is equally embodied in the display unit 140.

In an implementation of this document, four 5 bit digital sub-frame signals are generated by erasing lowest 2 bits of the digital signal in the 7 bit digital signal, but two 6 bit digital sub-frame signals may be generated by erasing the lowest 1 bit, and the number of digital sub-frame signals is not limited thereto.

Further, in an implementation of this document, in processing the 7 bit digital signal, a method of processing based on a value in which lower 2 bits are deleted is described, but this document is not limited to this method. An average of a plurality of digital sub-frame signals may be substantially equal to the digital signal before being processed. That is, in an implementation of this document, if the 7 bit digital signal is processed to “(1, 1, 2, 3)”, the 7 bit digital signal can be processed to “(0, 2, 2, 3)” or “(4, 0, 0, 3)”.

The controller 120 can select any one of red color, green color, and blue color digital signals and processes the selected signal to the n number of digital sub-frame signals. Accordingly, in a color in which it is necessary to express more variously a gray scale, the digital signal can be supplied to the display unit by increasing the number of bits of the digital signal through minutely correcting the digital signal by a gamma correction unit and then processing the digital signal to digital sub-frame signals by the processing unit. That is, a screen quality of a flat panel display without increasing the output bit number of the driver can be improved.

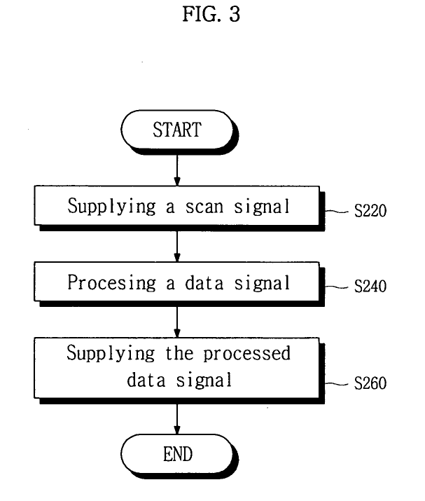

FIG. 3 is a flowchart illustrating a driving method of a flat panel display in an implementation of this document.

Referring to FIGS. 1 and 3, the step of supplying a scan signal (S220) is to supply a scan signal to the display unit 140 comprising sub-pixels positioned at an intersecting area of scan lines and data lines through the scan lines.

The step of processing a data signal (S240) is to process one digital signal supplied from the outside to the n number of digital sub-frame signals.

In the step of processing a data signal (S240), the digital signal is gamma-corrected by increasing the number of bits of a digital signal corresponding to one frame by at least one bit using the gamma correction unit 121 comprising the LUT, and the gamma-corrected digital signal can be processed to the n number of digital sub-frame signals by using the processing unit 122.

In the step of supplying a data signal (S240), the driver 130 converts the n number of digital sub-frame signals to the n number of analog sub-frame signals and supplies the n number of analog sub-frame signals to the display unit 140 during the n number of sub-frames so that an average of brightness of the n number of digital sub-frame signals and brightness of the corrected digital signal may be substantially equal to each other.

As described above, in this document, a magnitude of a driver can be decreased or sustained while a gray scale can be variously expressed, so that a device restriction problem according to a gray scale expression can be solved.

The invention being thus described, it will be obvious that the same may be varied in many ways. Such variations are not to be regarded as a departure from the spirit and scope of the invention, and all such modifications as would be obvious to one skilled in the art are intended to be comprised within the scope of the following claims.

What is claimed is:

1. A flat panel display comprising:
a controller comprising a processing unit that processes a digital signal corresponding to one frame to n number of digital sub-frame signals;
a driver that receives the digital sub-frame signals from the controller to generate the n number of analog sub-frame signals and supplies the analog sun-frame signals to a display unit; and
a display unit that receives the analog sub-frame signals to embody images,
wherein an average of brightness corresponding to the n number of digital sub-frame signals is substantially equal to brightness of the digital signal corresponding to one frame, and the number of bits of digital sub-frame signals is less than that the number of bits of the digital signal.

2. The flat panel display of claim 1, wherein the controller comprises a gamma correction unit that corrects a digital signal corresponding to one frame referring to a lookup table, and the digital signal is corrected by the gamma correction unit.

3. The flat panel display of claim 1, wherein the gamma correction unit corrects the digital signal by increasing the number of bits of the digital signal.

4. The flat panel display of claim 1, wherein the processing unit processes the digital signal to the n number of digital sub-frame by deleting lower at least one bit of the digital signal.

5. The flat panel display of claim 2, wherein a digital signal corresponding to the one frame corrected through the gamma correction unit is 7 bits, and the processing unit generates four 5 bit digital sub-frame signals by processing the 7 bit digital signal.

6. The flat panel display of claim 5, wherein at least two of the digital sub-frame signals are 5 bit signals which lower 2 bits of the 7 bit digital signal are deleted.

7. The flat panel display of claim 6, wherein at least any three of the digital sub-frame signals are 5 bit signals which lower 2 bits of the 7 bit digital signal are deleted; and
a magnitude of the remaining one is greater than a magnitude of the three sub-frame signals.

8. The flat panel display of claim 6, wherein a magnitude of the other two of digital sub-frame signals is greater than that of the any two, and a magnitude of any one of the other two is greater than that of the other one.

9. The flat panel display of claim 1, wherein the driver converts the n number of digital sub-frame signals to the n number of analog sub-frame signals so that brightness in which the n number of digital sub-frame signals display and brightness in which the digital signal displays are substantially equal to each other.

10. The flat panel display of claim 1, wherein the controller processes at least one of red color, green color, and blue color digital.

11. The flat panel display of claim 1, wherein the display unit comprises sub-pixels positioned at an intersection area of scan lines and data lines; and
each sub-pixel comprises a first electrode, a second electrode, and an organic light emitting layer interposed between two electrodes.

12. The flat panel display of claim 11, wherein each sub-pixel comprises at least one thin film transistor and capacitor.

13. A driving method of a flat panel display comprising:
supplying a scan signal to a display unit comprising sub-pixels positioned at an intersection area of scan lines and data lines through the scan lines;
processing a digital signal corresponding to one frame supplied from the outside to the n number of digital sub-frame signals; and
converting the n number of digital sub-frame signals into the n number of analog sub-frame signals and supplying the n number of analog sub-frame signals to the display unit through the data lines,
wherein an average of brightness corresponding to the n number of digital sub-frame signals is substantially equal to brightness of the digital signal before being processed; and
the number of bits of the n number of digital sub-frame signals is less than the number of bits of the digital signal.

14. The driving method of claim 13, wherein in the processing of a digital signal,
correcting the digital signal using a gamma correction unit comprising a loop-up table; and
processing the corrected digital signal to the n number of digital sub-frame signals using a processing unit.

15. The driving method of claim 14, wherein the gamma correction unit corrects the digital signal by increasing the number of bits of the digital signal.

16. The driving method of claim 14, wherein the processing unit processes the digital signal to the n number of digital sub-frame signals by cutting lower at least one bit of the digital signal.

17. The driving method of claim 16, wherein at least any two of the digital sub-frame signals have a value of 5 bits which lower 2 bits of a 7 bit digital signal are deleted.

18. The driving method of claim 16, wherein at least any three of the digital sub-frame signals have a value of 5 bits which lower 2 bits of a 7 bit digital signal are deleted; and
a magnitude of the remaining one is greater than that of the three sub-frame signals.

19. The driving method of claim 17, wherein a magnitude of other two of the digital sub-frame signals is greater than that of the any two, and a value of any one of the other two is greater than that of the other one.

20. The driving method of claim 13, wherein the n number of digital sub-frame signals are converted to the n number of analog sub-frame signals so that brightness in which the n number of digital sub-frame signals display and brightness in which the digital signal displays are substantially equal to each other.

21. The driving method of claim 13, wherein the digital signal is at least one of red color, green color, and blue color digital signals.
